(19) United States
(12) Patent Application Publication
(10) Pub. No.: US 2026/0340632 A1
(43) Pub. Date: Oct. 29, 2026

(54) SYSTEM AND METHOD TO ENABLE SHARDING IN A BLOCK CHAIN NETWORK

(71) Applicant: Sachin KUMAR, Greater Noida (IN)

(72) Inventors: Sachin KUMAR, Greater Noida (IN); Vaibhav TRIPATHI, GREATER NOIDA (IN); Jyotika SINGHAL, GREATER NOIDA (IN); Vijay KUMAR, GREATER NOIDA (IN)

(21) Appl. No.: 19/483,621

(22) PCT Filed: Jul. 4, 2023
(86) PCT No.: PCT/IB2023/056931

§ 371 Date: Nov. 12, 2025

(30) Foreign Application Priority Data
May 12, 2023 (IN) 202311033715

(51) Int. Cl. G06Q 20/40; H04L 9/00; H04L 9/32

(52) U.S. Cl. CPC G06Q 20/401; H04L 9/3247; H04L 9/50

(57) ABSTRACT

A system (10) to enable sharding in a block chain network (20) is disclosed. The system includes a processing subsystem (30) including an identification module associated with a plurality of nodes constituting the block chain network. The identification module identifies a predefined number of validator nodes from the plurality of nodes based on a plurality of parameters when a transaction is initiated between at least two nodes. The processing subsystem includes a validator module to enable the predefined number of validator nodes identified to validate the transaction initiated by a plurality of validation techniques by providing details of the transaction. The processing subsystem includes a management module to append a block corresponding to the transaction to the block chain network upon validating the transaction. The management module stores data corresponding to the transaction and a header of the block appended to the predefined number of validator nodes and the plurality of nodes excluding the predefined number

### EARLIEST PRIORITY DATE

This Application claims priority from a Complete patent application filed in India having Patent Application No. 202311033715, filed on May 12, 2023, and titled “SYSTEM AND METHOD TO ENABLE SHARDING IN A BLOCK CHAIN NETWORK”.

### FIELD OF INVENTION

Embodiments of the present disclosure relate to a field of block chains and more particularly to a system and method to enable sharding in a block chain network.

### BACKGROUND

Blockchain technology is evolving at a high pace given the increased use cases in various industries. A third generation blockchain enables the users to build a scalable and interoperable ecosystem. The blockchain technology has evolved past simple peer to peer transactions. Innovations have led to decentralized applications (DApps) being built on top of the blockchain and scalability has become an increasing challenge with the growth of data on blockchains. Increased data scalability is the ability of a blockchain system to process any number of transactions by adding nodes to the system partitioning the data into multiple shards that are maintained by different subsets of non-malicious nodes is a proven approach to improve the scalability of distributed databases.

In the currently existing most of the blockchain based systems high storage requirements and transaction speeds remain the biggest challenge. As of today, all the nodes in a blockchain are required to store the complete transactional data. However, such situation posing a requirement of ever increasing non sustainable infrastructure requirements. The storage requirements of a node for most of the chains as of today ranges in ~10 TB which is very high and keeps on increasing. Additionally, currently existing validator selection happens from the whole pool which additionally adds on to the speed issues. With technological advancement, dynamic sharding is also introduced. However, such dynamic sharding still requires data to be published across all the nodes.

Hence, there is a need for an improved system and a method to enable sharding in a block chain network to address the aforementioned issue(s).

### OBJECTIVE OF THE INVENTION

An objective of the invention includes to provide a system and a method to enable sharding in a block chain network.

### BRIEF DESCRIPTION

In accordance with an embodiment of the present disclosure, a system to enable sharding in a block chain network is provided. The system includes a processing subsystem hosted on a server. The processing subsystem is configured to execute on the block chain network to control bidirectional communications among a plurality of modules. The processing subsystem includes an identification module associated with a plurality of nodes constituting the block chain network. The identification module is configured to identify a predefined number of validator nodes from the plurality of nodes based on a plurality of parameters when a transaction is initiated between at least two nodes of the plurality of nodes. The processing subsystem also includes a validator module operatively coupled to the identification module. The validator module is configured to enable the predefined number of validator nodes identified to validate the transaction initiated by a plurality of validation techniques by providing one or more details of the transaction. The processing subsystem further includes a management module operatively coupled to the validator module. The management module is configured to append a block corresponding to the transaction to the block chain network upon validating the transaction. The management module is configured to store data corresponding to the transaction and a header of the block appended to the predefined number of validator nodes and the plurality of nodes excluding the predefined number of validator nodes respectively, thereby enabling sharding in the block chain network.

In accordance with another embodiment of the present disclosure, a method to enable sharding in a block chain network is provided. The method includes identifying, by an identification module, a predefined number of validator nodes from the plurality of nodes based on a plurality of parameters when a transaction is initiated between at least two nodes of the plurality of nodes. The method includes enabling, by a validator module, the predefined number of validator nodes identified to validate the transaction initiated by a plurality of validation techniques by providing one or more details of the transaction. The method further includes appending, by a management module, a block corresponding to the transaction to the block chain network upon validating the transaction. The method further transmitting, by the management module, data corresponding to the transaction and a header of the block appended to the predefined number of validator nodes and the plurality of nodes excluding the predefined number of validator nodes respectively, thereby enabling sharding in the block chain network.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system to enable sharding in a block chain network in accordance with an embodiment of the present disclosure;

FIG. 2 is a block diagram representation of one embodiment of the system of FIG. 1, in accordance with an embodiment of the present disclosure;

FIG. 3 is a schematic representation of an exemplary embodiment of the system of FIG. 1, in accordance with an embodiment of the present disclosure;

FIG. 4 is a block diagram of a computer or a server in accordance with an embodiment of the present disclosure; and

FIG. 5 is a flow chart representing the steps involved in a method to enable sharding in a block chain network in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and method to enable sharding in a block chain network. The system includes a processing subsystem hosted on a server and configured to execute on the block chain network to control bidirectional communications among a plurality of modules. The processing subsystem includes an identification module associated with a plurality of nodes constituting the block chain network. The identification module is configured to identify a predefined number of validator nodes from the plurality of nodes based on a plurality of parameters when a transaction is initiated between at least two nodes of the plurality of nodes. The processing subsystem also includes a validator module operatively coupled to the identification module. The validator module is configured to enable the predefined number of validator nodes identified to validate the transaction initiated by a plurality of validation techniques by providing one or more details of the transaction. The processing subsystem further includes a management module operatively coupled to the validator module. The management module is configured to append a block corresponding to the transaction to the block chain network upon validating the transaction. The management module is also configured to store data corresponding to the transaction and a header of the block appended to the predefined number of validator nodes and the plurality of nodes excluding the predefined number of validator nodes respectively, thereby enabling sharding in the block chain network.

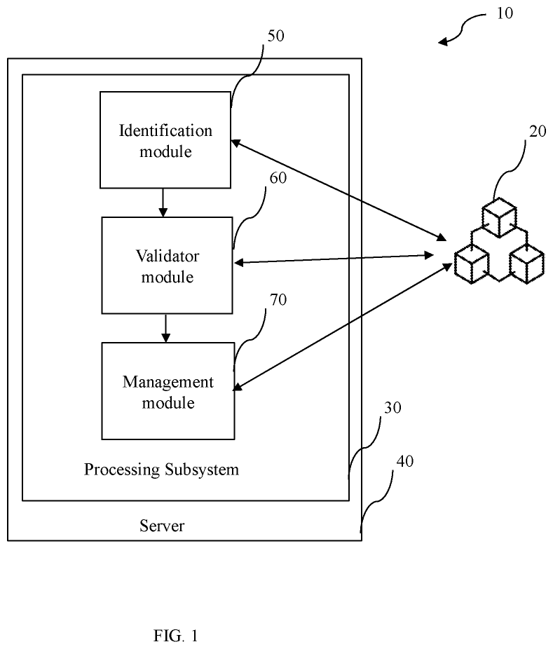

FIG. 1 is a block diagram representation of a system (10) to enable sharding in a block chain network (20) in accordance with an embodiment of the present disclosure. As used herein, the sharding of the block chain network (20) may be defined as a technique used to divide the block chain network (20) into smaller parts called “shards.” Each of the shards may have respective set of nodes responsible for validating transactions and maintaining the state of the shard. The system (10) includes a processing subsystem (30) hosted on a server (40) and configured to execute on the block chain network (20) to control bidirectional communications among a plurality of modules. The processing subsystem (30) includes an identification module (50) associated with a plurality of nodes constituting the block chain network (20). The identification module (50) is configured to identify a predefined number of validator nodes from the plurality of nodes based on a plurality of parameters when a transaction is initiated between at least two nodes of the plurality of nodes. In one embodiment, the predefined number of validator nodes may include a public node. In some embodiments, the predefined number of validator nodes may include a private node. In one embodiment, the plurality of parameters may include at least one of a stake score, capacity score, uptime score, utilization score, and environment social and governance score. For example consider a scenario in which the block chain network (20) is having different nodes such as node A, node B, node C, node D, and node E. Upon initiation of the transaction between the node A and the node B, the identification module (50) may identify the node C and the node D as the validator nodes.

The processing subsystem (30) also includes a validator module (60) operatively coupled to the identification module (50). The validator module (60) is configured to enable the predefined number of validator nodes identified to validate the transaction initiated by a plurality of validation techniques by providing one or more details of the transaction. In one embodiment, the plurality of validation techniques may include at least one of a digital signature, consensus mechanism, cryptographic hashes, merkle trees, and at least one predefined rule. In one embodiment, the one or more details may include at least one of a sender address, a receiver address, and an amount associated with the transaction. In continuation with the ongoing example, consider the scenario in which the transaction initiated between the node A and the node B may be a financial transaction involving transfer of specific amount from the node to the node B. The validator module (60) may validate the transaction between the node A and the node B through the validator nodes identified.

The processing subsystem (30) further includes a management module (70) operatively coupled to the validator module (60). The management module (70) is configured to append a block corresponding to the transaction to the block chain network (20) upon validating the transaction. The management module (70) is also configured to store data corresponding to the transaction and a header of the block appended to the predefined number of validator nodes and the plurality of nodes excluding the predefined number of validator nodes respectively, thereby enabling sharding in the block chain network (20). In one embodiment, the header of the block may include at least one of a time stamp of the block appended, co-relation to a prior block, an encrypted key for accessing the data corresponding to the transaction. In some embodiments, the data corresponding to the transaction comprises at least one of an amount transferred and a balance amount. In continuation to the ongoing example, upon validating the transaction occurred between the node A and the node B, the management module (70) may append an additional block to the block chain such as node F. Apart from that, the management module (70) may store the data related to the transaction in the validator nodes identified that is node C and the node D. The management module (70) may append the header of the node F to all other nodes excluding validator nodes identified.

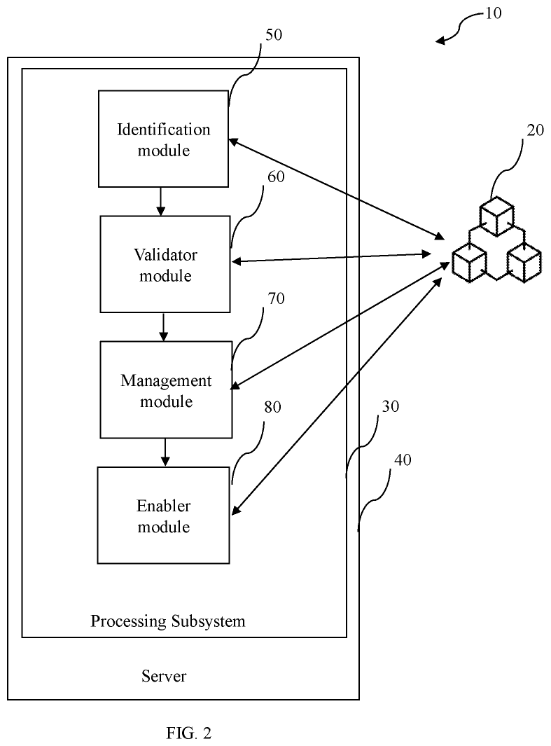

FIG. 2 is a block diagram representation of one embodiment of the system (10) of FIG. 1, in accordance with an embodiment of the present disclosure. The system (10) of FIG. 1 includes the identification module (50), the validator module (60) and the management module (70). In one embodiment, the system (10) of FIG. 1 may include the processing subsystem (30) including an enabler module (80) configured to enable the predefined number of validator nodes configured as a private node to function as public node upon meeting one or more predefined conditions. In continuation with an ongoing example, consider a scenario in which an entity X may be having a public block chain network (20). The enabler module (80) may enable the node C and the node D to function along with the public block chain network (20) when one or more smart contracts associated with the node C and the node D are getting validated.

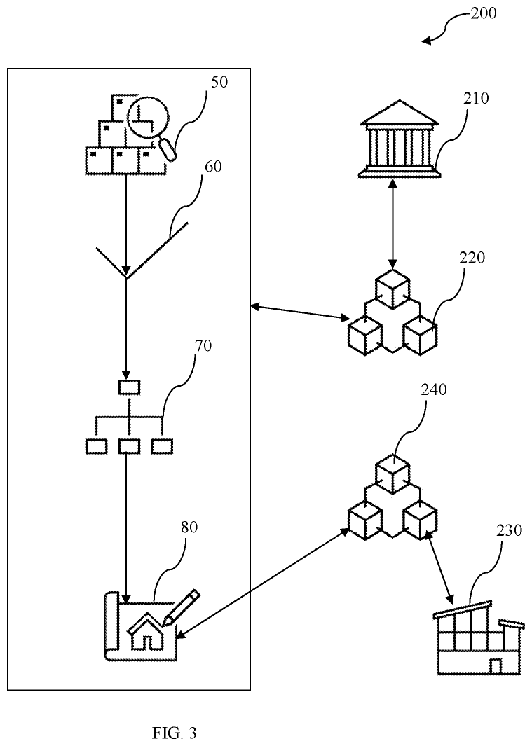

FIG. 3 is a schematic representation of an exemplary embodiment (200) of the system (10) of FIG. 1 in accordance with an embodiment of the present disclosure. Consider a scenario in which an entity X (210) is utilizing a block chain network Y (220). The block chain network Y (220) may be configured to function a private network. The block chain network Y (220) may be having nodes (not shown in FIG. 3) such as node P, node Q, node R, node S, and node T. Consider a scenario in which a transaction is initiated between the node Q and the node R. The transaction is associated with transfer of specific funds from the node Q to the node R. Upon detecting the transaction, the identification module (50) may identify the node P and the node S as the validator nodes. The validator module (60) may validate the transaction that occurred between the node Q and the node R by the validator nodes identified. The management module (70) may append an additional block that is a node U upon successful validation of the transaction by the validator module (60). The management module (70) may store the data related to the transaction in the validator nodes identified. Apart from that, the management module (70) may store the header of the node U in all other nodes excluding the validator nodes. Consider another scenario in which an entity Z (230) is using a public block chain network V (240). The enabler module (80) may enable the validator nodes identified to function along with the public block chain network V (240) when one or more smart contracts associated with the validator nodes are getting validated.

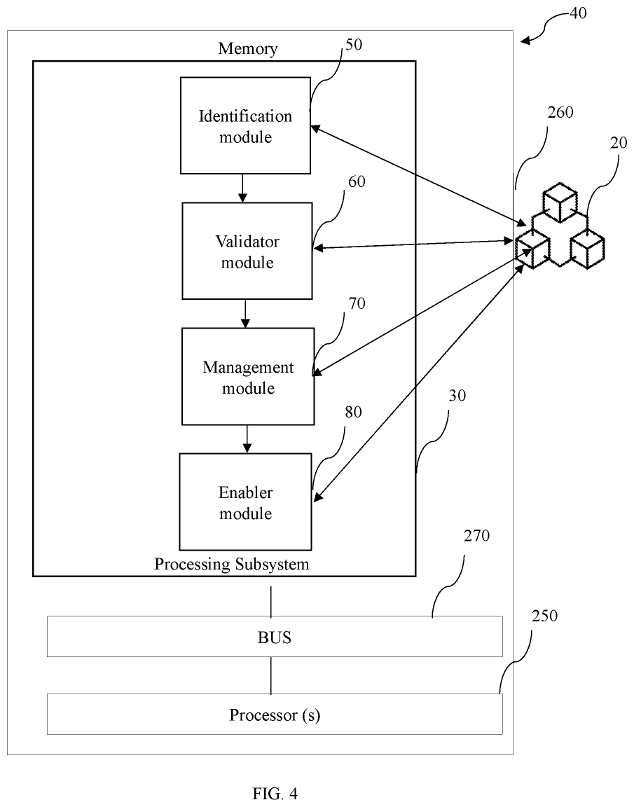

FIG. 4 is a block diagram of a computer or a server (40) in accordance with an embodiment of the present disclosure. The server (40) includes processor(s) (250), and memory (260) operatively coupled to the bus (270). The processor(s), as used herein, includes any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory includes several subsystems stored in the form of executable program which instructs the processor to perform the method steps illustrated in FIG. 1. The memory is substantially similar to the system (10) of FIG. 1. The memory has the following subsystems: the processing subsystem (30) including the identification module (50), the validator module (60), the management module (70) and the enabler module (80). The plurality of modules of the processing subsystem (30) performs the functions as stated in FIG. 1 and FIG. 2. The bus as used herein refers to be the internal memory channels or computer network that is used to connect computer components and transfer data between them. The bus includes a serial bus or a parallel bus, wherein the serial bus transmit data in bit-serial format and the parallel bus transmit data across multiple wires. The bus as used herein, may include but not limited to, a system bus, an internal bus, an external bus, an expansion bus, a frontside bus, a backside bus, and the like.

The processing subsystem (30) includes an identification module (50) associated with a plurality of nodes constituting the block chain network (20). The identification module (50) is configured to identify a predefined number of validator nodes from the plurality of nodes based on a plurality of parameters when a transaction is initiated between at least two nodes of the plurality of nodes. The processing subsystem (30) also includes a validator module (60) operatively coupled to the identification module (50). The validator module (60) is configured to enable the predefined number of validator nodes identified to validate the transaction initiated by a plurality of validation techniques by providing one or more details of the transaction. The processing subsystem (30) further includes a management module (70) operatively coupled to the validator module (60). The management module (70) is configured to append a block corresponding to the transaction to the block chain network (20) upon validating the transaction. The management module (70) is configured to store data corresponding to the transaction and a header of the block appended to the predefined number of validator nodes and the plurality of nodes excluding the predefined number of validator nodes respectively, thereby enabling sharding in the block chain network (20).

The processing subsystem (30) includes the enabler module (80) configured to enable the predefined number of validator nodes configured as a private node to function as public node upon meeting one or more predefined conditions.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s).

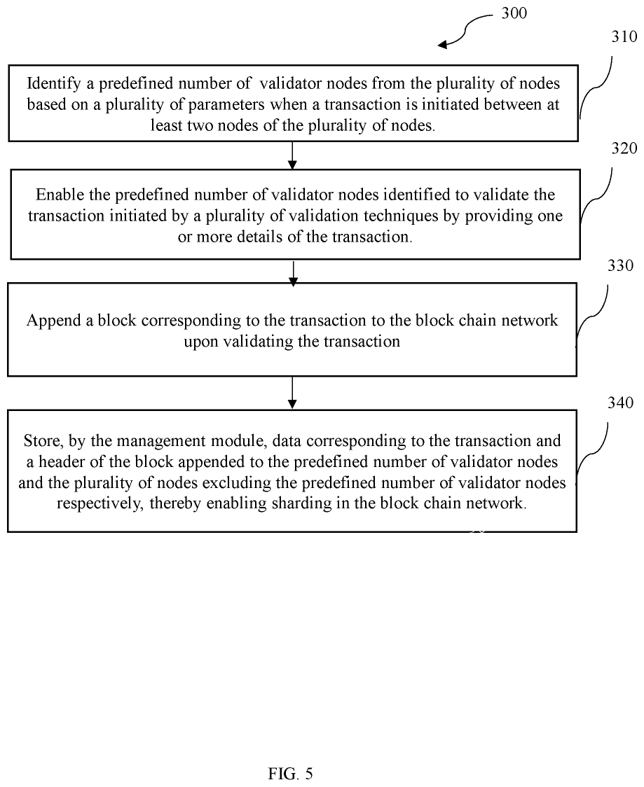

FIG. 5 is a flow chart representing the steps involved in a method (300) to enable sharding in a block chain network in accordance with an embodiment of the present disclosure. The method (300) includes identifying a predefined number of validator nodes from the plurality of nodes based on a plurality of parameters when a transaction is initiated between at least two nodes of the plurality of nodes in step 310. In one embodiment, identifying a predefined number of validator nodes from the plurality of nodes based on a plurality of parameters when a transaction is initiated between at least two nodes of the plurality of nodes includes identifying a predefined number of validator nodes from the plurality of nodes based on a plurality of parameters when a transaction is initiated between at least two nodes of the plurality of nodes by an identification module. In one embodiment, the predefined number of validator nodes may include a private node. In one embodiment, the predefined number of validator nodes may include a public node. In one embodiment, the plurality of parameters may include at least one of a stake score, capacity score, uptime score, utilization score, and environment social and governance score.

The method (300) also includes enabling the predefined number of validator nodes identified to validate the transaction initiated by a plurality of validation techniques by providing one or more details of the transaction in step 320. In one embodiment, enabling the predefined number of validator nodes identified to validate the transaction initiated by a plurality of validation techniques by providing one or more details of the transaction includes enabling the predefined number of validator nodes identified to validate the transaction initiated by a plurality of validation techniques by providing one or more details of the transaction by a validator module. In one embodiment, the plurality of validation techniques may include at least one of a digital signature, consensus mechanism, cryptographic hashes, merkle trees, and at least one predefined rule.

The method (300) further includes appending a block corresponding to the transaction to the block chain network upon validating the transaction in step 330. In one embodiment, appending a block corresponding to the transaction to the block chain network upon validating the transaction includes appending a block corresponding to the transaction to the block chain network upon validating the transaction by a management module.

The method (300) also includes storing data corresponding to the transaction and a header of the block appended to the predefined number of validator nodes and the plurality of nodes excluding the predefined number of validator nodes respectively, thereby enabling sharding in the block chain network in step 340. In one embodiment, storing data corresponding to the transaction and a header of the block appended to the predefined number of validator nodes and the plurality of nodes excluding the predefined number of validator nodes respectively includes storing data corresponding to the transaction and a header of the block appended to the predefined number of validator nodes and the plurality of nodes excluding the predefined number of validator nodes respectively by the management module. In one embodiment, the one or more details may include at least one of a sender address, a receiver address, and an amount associated with the transaction. In some embodiments, the header of the block may include, at least one of a time stamp of the block appended, co-relation to a prior block, an encrypted key for accessing the data corresponding to the transaction. Various embodiments of the system and method to enable sharding in a block chain network described above enable various advantages. Combination of the identification module, the validator module and the management module are capable splitting and storing the data related to transaction in a decentralized manner, thereby increasing scalability and speed of the block chain network. The enabler module provides a way for enabling the predefined number of validator nodes configured as the private nodes to function as public nodes, thereby providing interoperability to the block chain network.

It will be understood by those skilled in the art that the foregoing general description and the following detailed description are exemplary and explanatory of the disclosure and are not intended to be restrictive thereof. While specific language has been used to describe the disclosure, any limitations arising on account of the same are not intended.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all the acts need to be necessarily performed. Also, those acts that are not dependent on other acts may be performed in parallel with the other acts. The scope of embodiments is by no means limited by these specific examples.

I claim:

1. A system (10) to enable sharding in a block chain network (20) comprising:
characterized in that:
a processing subsystem (30) hosted on a server (40) and configured to execute on the block chain network (20) to control bidirectional communications among a plurality of modules comprising:
an identification module (50) associated with a plurality of nodes constituting the block chain network (20), wherein the identification module (50) is configured to identify a predefined number of validator nodes from the plurality of nodes based on a plurality of parameters when a transaction is initiated between at least two nodes of the plurality of nodes;
a validator module (60) operatively coupled to the identification module (50), wherein the validator module (60) is configured to enable the predefined number of validator nodes identified to validate the transaction initiated by a plurality of validation techniques by providing one or more details of the transaction;
a management module (70) operatively coupled to the validator module (60), wherein the management module (70) is configured to:
append a block corresponding to the transaction to the block chain network upon validating the transaction; and
store data corresponding to the transaction and a header of the block appended to the predefined number of validator nodes and the plurality of nodes excluding the predefined number of validator nodes respectively, thereby enabling sharding in the block chain network (20).

2. The system (10) as claimed in claim 1, wherein the predefined number of validator nodes comprises a private node.

3. The system (10) as claimed in claim 1, wherein the predefined number of validator nodes comprises a public node.

4. The system (10) as claimed in claim 1, wherein the plurality of parameters comprises at least one of a stake score, capacity score, uptime score, utilization score, and environment social and governance score.

5. The system (10) as claimed in claim 1, wherein the plurality of validation techniques comprises at least one of a digital signature, consensus mechanism, cryptographic hashes, merkle trees, and at least one predefined rule.

6. The system (10) as claimed in claim 1, wherein the one or more details comprises at least one of a sender address, a receiver address, and an amount associated with the transaction.

7. The system (10) as claimed in claim 1, wherein the header of the block comprises at least one of a time stamp of the block appended, co-relation to a prior block, an encrypted key for accessing the data corresponding to the transaction.

8. The system (10) as claimed in claim 1, wherein the data corresponding to the transaction comprises at least one of an amount transferred and a balance amount.

9. The system (10) as claimed in claim 1, wherein the processing subsystem (30) comprises an enabler module (80) configured to enable the predefined number of validator nodes configured as a private node to function as public node upon meeting one or more predefined conditions.

10. A method (300) to enable sharding in a block chain network comprising:
characterized in that:
identifying, by an identification module, a predefined number of validator nodes from the plurality of nodes based on a plurality of parameters when a transaction is initiated between at least two nodes of the plurality of nodes; (310)
enabling, by a validator module, the predefined number of validator nodes identified to validate the transaction initiated by a plurality of validation techniques by providing one or more details of the transaction; (320)
appending, by a management module, a block corresponding to the transaction to the block chain network upon validating the transaction; (330) and
storing, by the management module, data corresponding to the transaction and a header of the block appended to the predefined number of validator nodes and the plurality of nodes excluding the predefined number of validator nodes respectively, thereby enabling sharding in the block chain network. (340)
